(19) United States
(12) Patent Application Publication
(10) Pub. No.: US 2016/0012225 A1
(43) Pub. Date: Jan. 14, 2016

(54) SYSTEM AND METHOD FOR THE DETECTION OF MALWARE

(71) Applicant: AVG Netherlands B.V., Amsterdam (NL)

(72) Inventor: Ryan Hicks, Brno (CZ)

(21) Appl. No.: 14/862,570

(22) Filed: Sep. 23, 2015

Related U.S. Application Data
(63) Continuation of application No. 12/550,025, filed on Aug. 28, 2009, now abandoned.
(60) Provisional application No. 61/092,848, filed on Aug. 29, 2008.

(51) Int. Cl. G06F 21/56; G06N 5/02

(52) U.S. Cl. CPC G06F 21/563; G06N 5/02

(57) ABSTRACT

A method of automatically identifying malware may include receiving, by an expert system knowledge base, an assembly language sequence from a binary file, identifying an instruction sequence from the received assembly language sequence, and classifying, by the expert system knowledge base, the instruction sequence as threatening, non-threatening or non-classifiable by applying one or more rules of the expert system knowledge base to the instruction sequence. If the instruction sequence is classified as threatening, information may be transmitted to a code analysis component and a user may be notified that the binary file includes malware. The information may include one or more of the following: the instruction sequence, a label comprising an indication that the instruction sequence is threatening, and a request that one or more other assembly language sequences from the binary file be searched for at least a portion of the instruction sequence.

### CROSS REFERENCE TO RELATED APPLICATIONS

This application is a continuation of U.S. application Ser. No. 12/550,025 filed Aug. 28, 2009 which claims the benefit of the filing date of Provisional Patent Application No. 61/092,848 filed Aug. 29, 2008 both of which are incorporated by reference in their entirety.

### BACKGROUND

A binary file is often transferred between many computing devices. A computing device that receives a binary file is usually not aware of the origin of the file or whether the code that it receives is safe. To ensure the security of a computing device, a binary file can be disassembled to determine if the file contains malware such as viruses, worms, Trojan Horses and/or the like.

Typically, a disassembler translates a binary file from machine language into assembly language. Some disassemblers are interactive and allow an expert programmer to make annotations, corrections, clarifications or decisions regarding how the disassembler analyzes a file. For example, a disassembler may signal when a new function or particular section of code appears. When an identified action occurs, a particular section of the code may be labeled for future reference. However, analysis of unknown executables can be a time consuming process that is usually performed manually by specially trained personnel, or automatically by the use of statistical methods.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a method of automatically identifying malware may include receiving, by an expert system knowledge base, an assembly language sequence from a binary file, identifying an instruction sequence from the received assembly language sequence, and classifying, by the expert system knowledge base, the instruction sequence as threatening, non-threatening or non-classifiable by applying one or more rules of the expert system knowledge base to the instruction sequence. If the instruction sequence is classified as threatening, information may be transmitted to a code analysis component and a user may be notified that the binary file includes malware. The information may include one or more of the following: the instruction sequence, a label comprising an indication that the instruction sequence is threatening, and a request that one or more other assembly language sequences from the binary file be searched for at least a portion of the instruction sequence.

In an embodiment, a method of automatically identifying malware may include receiving, by an expert system knowledge base, an assembly language sequence from a binary file, identifying an instruction sequence from the received assembly language sequence, and classifying, by the expert system knowledge base, the instruction sequence as threatening, non-threatening or non-classifiable by applying one or more rules of the expert system knowledge base to the instruction sequence. If the instruction sequence is classified as non-threatening, information may be transmitted to a code analysis component and a second instruction sequence may be requested. The information may include one or more of the following: the instruction sequence and a label comprising an indication that the instruction sequence is non-threatening.

In an embodiment, a method of automatically identifying malware may include receiving, by an expert system knowledge base, an assembly language sequence from a binary file, identifying an instruction sequence from the received assembly language sequence, and classifying, by the expert system knowledge base, the instruction sequence as threatening, non-threatening or non-classifiable by applying one or more rules of the expert system to the instruction sequence. If the instruction sequence is classified as non-classifiable, the method may include transmitting a request to a code analysis component that the assembly language sequence be reanalyzed, receiving a new instruction sequence corresponding to the reanalyzed assembly language sequence, and classifying the new instruction sequence as threatening, non-threatening or non-classifiable.

In an embodiment, a method of automatically identifying malware may include analyzing, by a code analysis component, a binary file to generate an assembly language sequence and a corresponding instruction sequence, transmitting the instruction sequence to an expert system knowledge base and receiving, from the expert system knowledge base, classification information associated with the instruction sequence. If the classification information identifies the instruction sequence as threatening, the method may include identifying one or more other assembly language sequences from the binary file that comprise at least a portion of the instruction sequence, and transmitting at least one of the identified assembly language sequences to the expert system knowledge base. If the classification information identifies the instruction sequence as non-threatening, the method may include transmitting a second instruction sequence to the expert system knowledge base. If the classification information identifies the instruction sequence as non-classifiable, the method may include reanalyzing the assembly language sequence to produce a new instruction sequence, and transmitting the new instruction sequence to the expert system knowledge base.

In an embodiment, a system for automatically identifying malware may include a code analysis component configured to identify an assembly language sequence including one or more instruction sequences from a binary file, and an expert system knowledge base in communication with the code analysis component. The expert system knowledge base may be configured to classify the instruction sequence as threatening, non-threatening or non-classifiable using one or more rules.

### BRIEF DESCRIPTION OF THE DRAWINGS

Aspects, features, benefits and advantages of the embodiments described herein will be apparent with regard to the following description, appended claims, and accompanying drawings where:

FIG. 1 illustrates an exemplary malware detection system according to an embodiment.

FIG. 2 illustrates an exemplary expert system knowledge base according to an embodiment.

FIG. 3 illustrates a flowchart of an exemplary method for detecting and analyzing malware according to an embodiment.

FIG. 4 illustrates a block diagram of an exemplary system that may be used to contain or implement program instructions according to an embodiment.

FIGS. 5 and 6 illustrate exemplary instruction sequences according to an embodiment.

### DETAILED DESCRIPTION

Before the present methods and systems are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

As used herein and in the appended claims, the singular forms “a,” “an,” and “the” include the plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

For the purpose of the description below, a “node” refers to a sequence of instructions within an assembly language sequence that is executed by a processor.

An “assembly language” refers to a computer programming language that implements a symbolic representation of numeric machine codes.

An “assembly language sequence” refers to a sequence of nodes written in assembly language.

A “binary file” refers to a computer file that includes data encoded in binary format. An executable file is a type of binary file.

“Malware” is malicious software designed to disrupt, infiltrate or damage a computer system. Examples of malware include viruses, worms, trojan horses, adware, spyware, root kits and/or the like.

An “expert system” is artificial intelligence software and/or firmware that is designed to simulate the decision making process of a human in a specific problem domain.

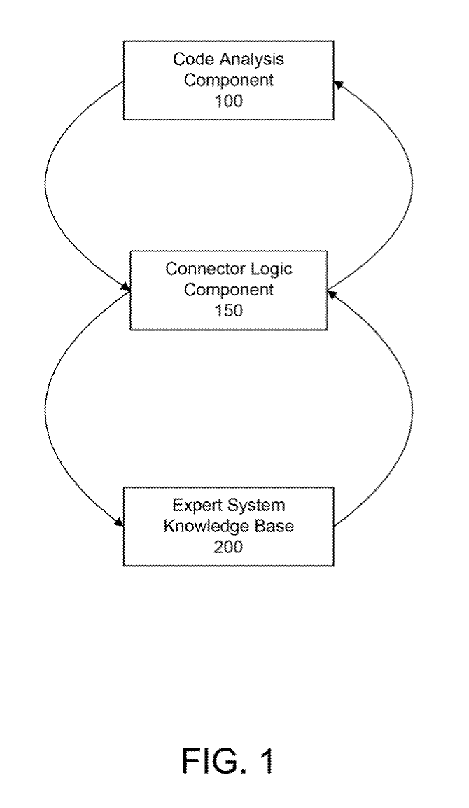

FIG. 1 illustrates a malware detection system according to an embodiment. A malware detection system may include a code analysis component 100, an expert system knowledge base 200 and/or a connector logic component 150. In an embodiment, the code analysis component 100, expert system knowledge base 200 and/or connector logic component 150 may be implemented using software, hardware or a combination of software and hardware. In an embodiment, the code analysis component 100, expert system knowledge base 200 and/or connector logic component 150 may reside on the same computing device. Alternatively, the code analysis component 100, expert system knowledge base 200 and/or connector logic component 150 may reside on different computing devices in communication with one another.

In an embodiment, a code analysis component 100 may analyze binary files such as, but not limited to, executables. In an embodiment, a code analysis component 100 may statically or dynamically analyze binary files. Static analysis may include analyzing a binary file that is not currently being executed. In comparison, dynamic analysis may include analyzing a binary file while the binary file is being executed.

In an embodiment, a code analysis component may be implemented using software, hardware or a combination of software and hardware. In an embodiment a code analysis component 100 may include a disassembler, a debugger, a decompiler and/or the like. For example, the code analysis component 100 may be a disassembler, such as IDA Pro.

A code analysis component may analyze a binary file to create an assembly language sequence. In an embodiment, the assembly language sequence may include a human-readable representation of the binary file. The code analysis component 100 may include internal rules and/or operations which may be used to create an assembly language sequence from the binary file. The code analysis component 100 may analyze the assembly language sequence to determine an instruction sequence.

In an embodiment, a code analysis component 100 may interact with external devices to analyze a binary file. For example, as discussed below, the code analysis component 100 may communicate with an expert system knowledge base 200.

As illustrated by FIG. 1, the malware detection system may include an expert system knowledge base 200. In an embodiment, an expert system knowledge base 200 may include a representation of a human's expertise in a particular area. For example, an expert system knowledge base 200 may include information, data, rules and/or the like to model the knowledge and practices of an experienced computer analyst.

In an embodiment, the expert system knowledge base 200 may be implemented using the C Language Integrated Production System (“CLIPS”). CLIPS is a programming language and software tool that may be used to create expert systems.

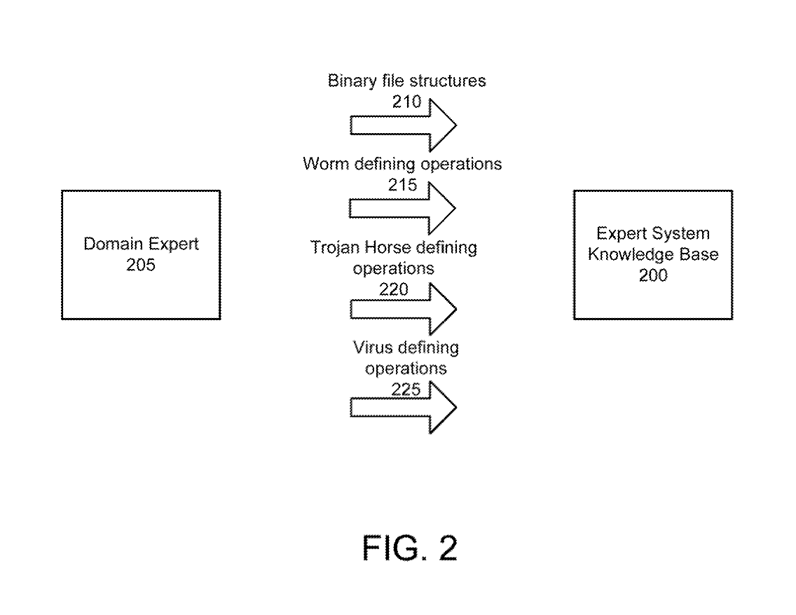

FIG. 2 illustrates an expert system knowledge base according to an embodiment. The expert system knowledge base 200 may include internal rules and/or operations. In an embodiment, these internal rules and/or operations may be applied to an instruction sequence from an assembly language sequence to determine whether the assembly language sequence contains malware. In an embodiment, the internal rules and/or operations may represent the encoding of human expertise.

In an embodiment, a domain expert 205 may populate the expert system knowledge base 200. A domain expert may be, but is not limited to, a human being who has expertise in analyzing malware. In an embodiment, a domain expert 205 may be a computing device configured to provide the expert system knowledge base 200 with internal rules and/or operations that may represent the encoding of human expertise. For example, a computing device may automatically provide the expert system knowledge base 200 with updates, enhancements or the like for one or more internal rules and/or operations.

In an embodiment, the expert system knowledge base 200 may be populated with binary file structures 210. A binary file structure may be a template that depicts one or more portions of a binary file and/or a sequence of the portions in a binary file. The Binary file structures 210 may be used to analyze whether a file structure is proper. For example, a binary file structure 210 may be analyzed to determine if the header on the file conforms to a protocol.

In an embodiment, the expert system knowledge base 200 may be populated with worm defining operations 215. Worm defining operations 215 may identify instruction sequences which replicate an assembly language sequence.

In an embodiment, the expert system knowledge base 200 may be populated with Trojan Horse defining operations 220. Trojan Horse defining operations 220 may identify instruction sequences in an assembly language sequence that are associated with one or more Trojan Horses.

In an embodiment, the expert system knowledge base 200 may be populated with virus defining operations 225. Virus defining operations 225 may identify self-replicating instruction sequences in an assembly language sequence. Additional and/or alternative operations may be included in the expert system knowledge base 200.

Referring back to FIG. 1, the malware detection system may include a connector logic component 150. A connector logic component 150 may enable communication between the code analysis component 100 and the expert system knowledge base 200.

In an embodiment, the assembly language sequence sent from the code analysis component 100 may be in a format which cannot be directly processed by the expert system knowledge base 200. The code analysis component 100 may communicate the assembly language sequence to the connector logic component 150. The connector logic component 150 may convert the instruction sequence into a format that the expert system knowledge base 200 can process. The connector logic component 150 may send the newly converted instruction sequence to the expert system knowledge base 200.

Similarly, the connector logic component may obtain information from the expert system knowledge base 200. The connector logic component may convert the information from the expert system knowledge base 200 into a format that is readable by the code analysis component 100 and transmit the converted information to the code analysis component.

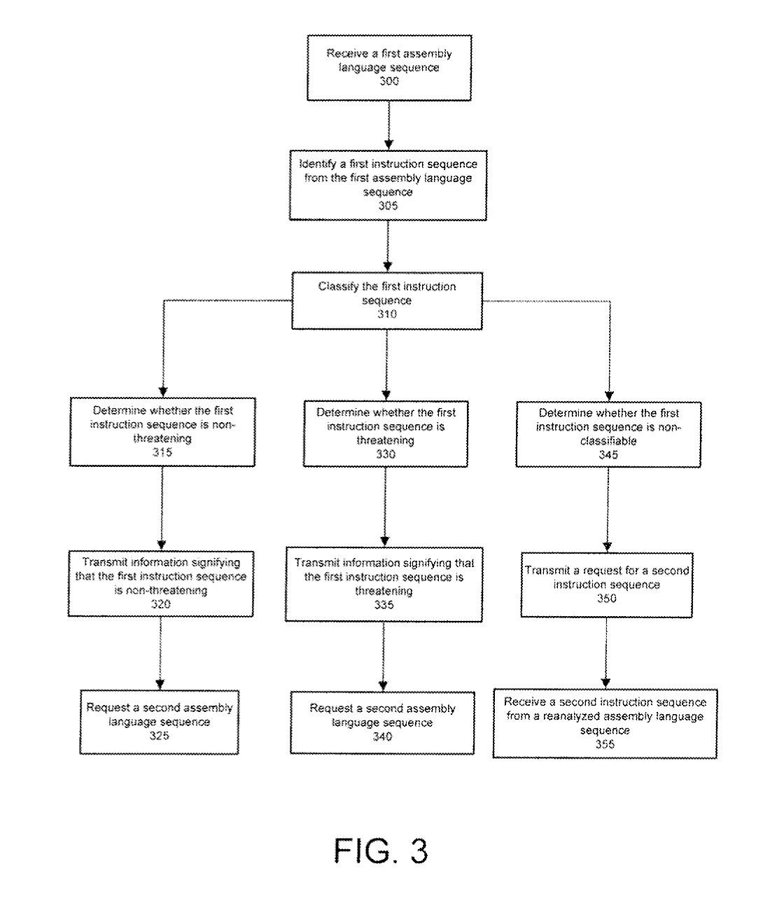

FIG. 3 depicts a flowchart of a method for detecting and analyzing malware according to an embodiment. A binary file may be received by the code analysis component. The code analysis component may analyze the file to obtain an assembly language sequence and an instruction sequence. The code analysis component may send the assembly language sequence with the instruction sequence to the expert system knowledge base via the connector logic component.

The expert system knowledge base may receive 300 the assembly language sequence. In an embodiment, the expert system knowledge base may identify 305 the instruction sequence from the assembly language sequence.

The expert system knowledge base may apply internal operations and/or rules to classify 315 the instruction sequence. In an embodiment, the classification may be used to determine if the instruction sequence contains malware. For example, in an embodiment, the expert system knowledge base may classify the instruction sequence as non-threatening 315, threatening 330 or non-classifiable 345. Additional and/or alternate classifications may be used within the scope of this disclosure.

In an embodiment, the expert system knowledge base may traverse through the nodes and branches of a received instruction sequence using one or more internal rules and/or operations. In an embodiment, the expert system knowledge base apply a group of precedential rules to the received instruction sequence. Each rule in the set of precedential rules may have a ranking with respect to the other precedential rules in the set. In an embodiment, the rules may be ranked based on the number of matches between each rule and the instruction sequence. For example, the instruction sequences that are most similar to the match criteria of a rule may cause that rule to be given a highest priority for a given traversal. Alternatively, the instruction sequences that are least similar to the match criteria of a rule may cause that rule to be given a lowest priority for a given traversal.

CLIPS provides conflict resolution strategies such as a complexity strategy and a simplicity strategy which give precedence to the most and least specific matches, respectively. In an embodiment, such strategies may be employed to rank the rules as to those which most specifically match the instruction sequence.

In an embodiment, the expert system knowledge base may apply the rule associated with the highest precedence to the instruction sequence. In an embodiment, one or more additional precedential rules from the group may be applied, in the order of their precedence, to the instruction sequence until the instruction sequence is classified or until all precedential rules have been applied.

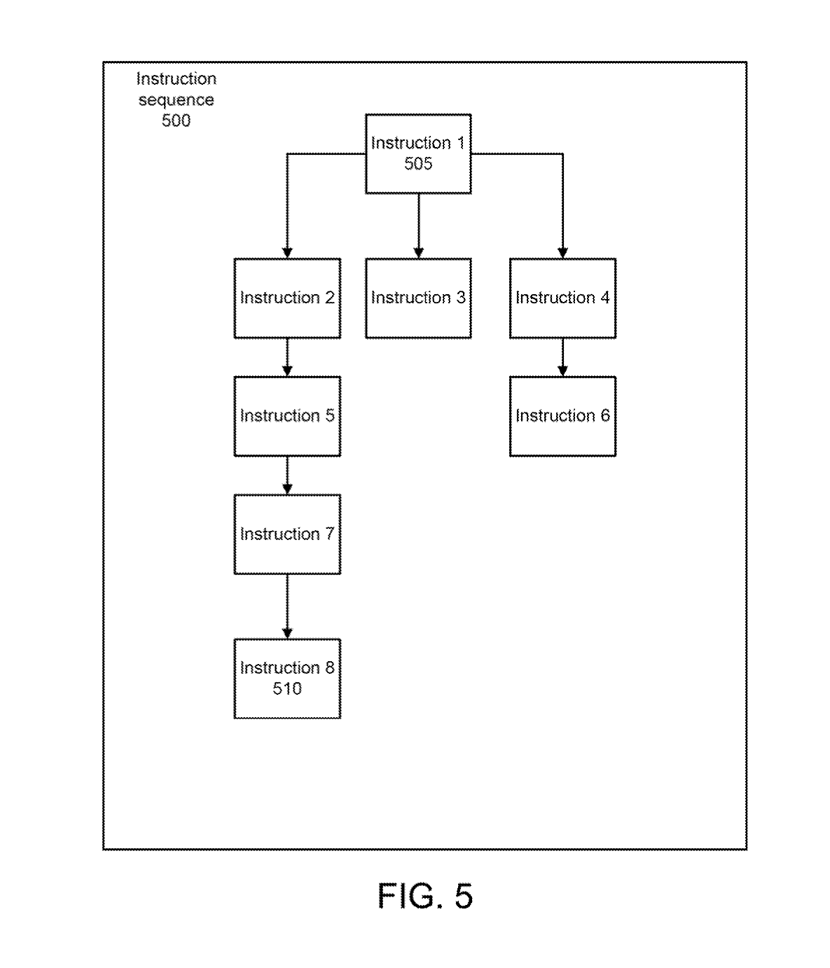

If, when applying a rule or rules, the expert system knowledge base traverses the instruction sequence from start to finish, then the instruction sequence may be classified as non-threatening 315. For example, FIG. 5 illustrates an exemplary instruction sequence according to an embodiment. If the expert system knowledge base is able to traverse the entire instruction sequence 500 from start (Instruction 1 505) to finish (Instruction 8 510), then the instruction sequence 500 may be classified as non-threatening.

In an embodiment, the expert system knowledge base may transmit 320 information signifying that the instruction sequence is non-threatening to the code analysis component. In an embodiment, the information may include a label attached to the instruction sequence indicating that the instruction sequence is non-threatening.

In an embodiment, in response to classifying an instruction sequence as non-threatening, the expert system knowledge base may request 325 a new assembly sequence with a new instruction sequence to analyze from the code analysis component.

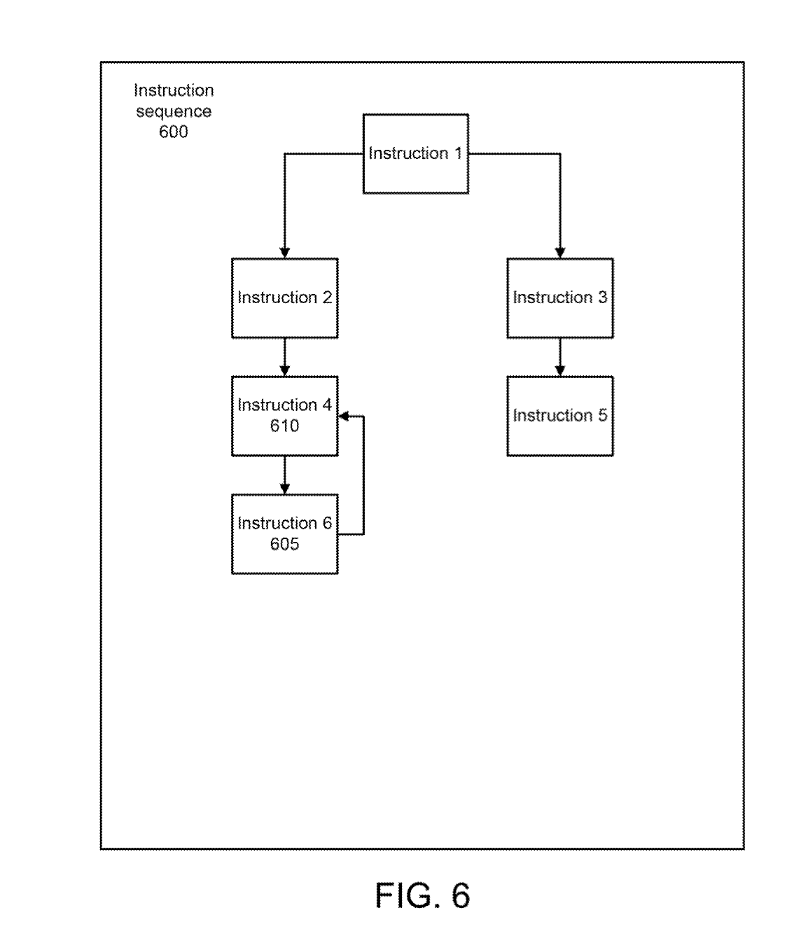

In an embodiment, the expert system knowledge base may classify an instruction sequence as threatening 330 if the expert system knowledge base is unable to traverse each instruction of the instruction sequence. For example, the expert system knowledge base may analyze the instruction sequence by traversing the instructions of the instruction sequence to determine if there is malware. For example, a loop may be an indicator of malware. If during the traversal, the expert system knowledge base arrives at an instruction that it already analyzed, the expert system knowledge base may determine that the instruction sequence forms a loop. In an embodiment, the expert system knowledge base may classify an instruction sequence having one or more loops as threatening. FIG. 6 illustrates an exemplary instruction sequence according to an embodiment. As illustrated by FIG. 6, the instruction sequence 600 may be classified as threatening because it includes a loop from Instruction 6 605 to Instruction 4 610.

In an embodiment, other activities that may be indicative of malware or other nefarious behaviors may include encryption/decryption routines, replicating code, key logging, independent initiation of network communication, communication with known hostile or suspicious network hosts and/or the like. As such, an instruction sequence that includes one or more of these activities may be classified as threatening. Additional and/or alternate activities may be indicative of malware within the scope of this disclosure.

In an embodiment, the expert system knowledge base may transmit 335 information signifying that the instruction sequence is threatening to the code analysis component. The information may be sent to the code analysis component via the connector logic component, which may translate the information into a form readable by the code analysis component. In an embodiment, the information may include a label attached to the instruction sequence indicating that the instruction sequence is threatening.

In an embodiment, the information may include a request that the code analysis component search other assembly language sequences for at least a portion of an instruction sequence that was previously analyzed 340. For example, the code analysis component may search other assembly language sequences for the loop discussed in the previous example. In an embodiment, the code analysis component may use its internal operations and/or rules to translate and/or analyze the information to determine whether at least a portion of an instruction sequence is present inside the assembly language sequences. If the code analysis component finds the same instruction sequence or portion thereof, the code analysis component may send the relevant assembly language sequence and instruction sequence to the expert system knowledge base.

In an embodiment, the expert system knowledge base may determine 345 whether an instruction sequence is non-classifiable. An instruction sequence may be identified as being non-classifiable if the expert system knowledge base is unable to determine whether the instruction sequence is threatening. For example, a programmer who created a binary file may have intentionally used methods to obfuscate the workings of the file prevent the code analysis component from issuing the correct instruction sequence. As such, the code analysis component may send an incomplete or nonsensical instruction sequence to the expert system knowledge base via the connector logic component.

The expert system knowledge base may analyze each node of the instruction sequence using its internal rules and/or operations. Based on its analysis, the expert system knowledge base may transmit 350 a request to the code analysis component to reinterpret a particular node or series of nodes. For example, the expert system knowledge base may request that the code analysis component generate a new instruction sequence for a particular node.

In an embodiment, the request may include alternate considerations for the code analysis component in analyzing the assembly sequence. For example, in some instances, the code analysis component may not be able to properly analyze an assembly sequence. As such, it may be necessary for the expert system knowledge base to provide information to the code analysis component that will allow the analysis to continue. For example, the expert system knowledge base may detect that an incorrect instruction sequence should be altered or ignored to allow the analysis to continue. In an embodiment, this information may be included in a request to the code analysis component.

In an embodiment, the code analysis component may use its internal rules and/or operations reanalyze the assembly language sequence and instruction sequence. The expert system knowledge base may receive 345 the reanalyzed assembly language sequence and new instruction sequence from the code analysis component via the connector logic component. The expert system knowledge base may traverse the new instruction sequence to determine its classification.

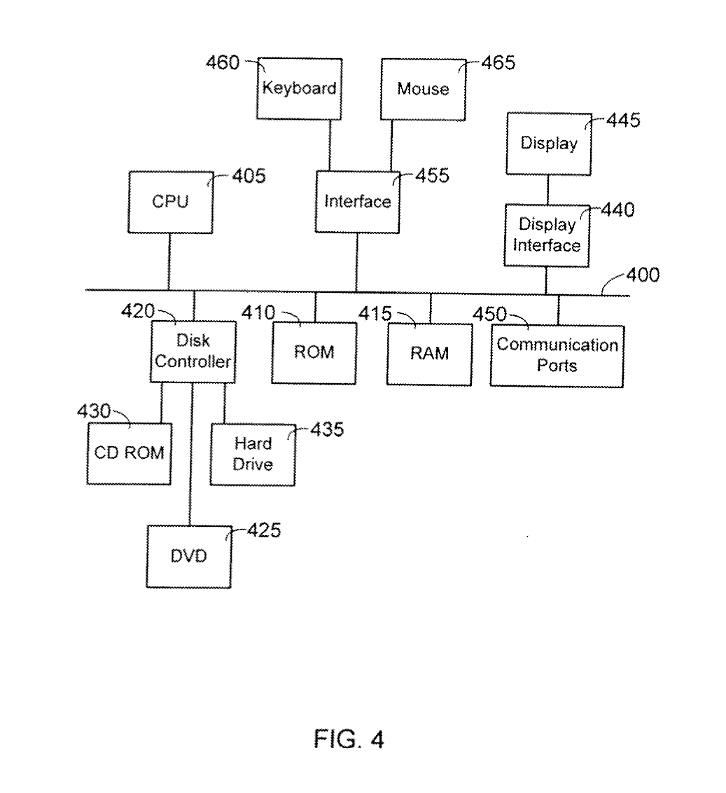

FIG. 4 depicts a block diagram of an exemplary system that may be used to contain or implement program instructions according to an embodiment. Referring to FIG. 4, a bus 400 serves as the main information highway interconnecting the other illustrated components of the hardware. CPU 405 is the central processing unit of the system, performing calculations and logic operations required to execute a program. Read only memory (ROM) 410 and random access memory (RAM) 415 constitute exemplary memory devices or storage media.

A disk controller 420 interfaces with one or more optional disk drives to the system bus 400. These disk drives may include, for example, external or internal DVD drives 425, CD ROM drives 430 or hard drives 435. As indicated previously, these various disk drives and disk controllers are optional devices.

Program instructions may be stored in the ROM 410 and/or the RAM 415. Optionally, program instructions may be stored on a computer readable storage medium, such as a hard drive, a compact disk, a digital disk, a memory or any other tangible recording medium.

An optional display interface 440 may permit information from the bus 400 to be displayed on the display 445 in audio, graphic or alphanumeric format. Communication with external devices may occur using various communication ports 450.

In addition to the standard computer-type components, the hardware may also include an interface 455 which allows for receipt of data from input devices such as a keyboard 460 or other input device 465 such as a mouse, remote control, touch pad or screen, pointer and/or joystick.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following embodiments.

What is claimed is:

1. A method of automatically identifying malware, the method comprising:
receiving, by an expert system knowledge base, an assembly language sequence from a binary file;
identifying an instruction sequence from the received assembly language sequence;
classifying, by the expert system knowledge base, the instruction sequence as threatening, non-threatening or non-classifiable by applying one or more rules of the expert system knowledge base to the instruction sequence;
if the instruction sequence is classified as threatening, transmitting information to a code analysis component, wherein the information comprises one or more of the following:
the instruction sequence,
a label comprising an indication that the instruction sequence is threatening, and
a request that one or more other assembly language sequences from the binary file be searched for at least a portion of the instruction sequence; and
notifying a user that the binary file includes malware.

2. The method of claim 1, wherein applying one or more rules comprises applying one or more rules written in C Language Integrated Production System language.

3. The method of claim 1, wherein classifying the instruction sequence comprises one or more of the following:
applying one or more rules to the instruction sequence to determine whether a binary file structure of the binary file is proper;
applying one or more worm defining operations to determine whether the instruction sequence comprises one or more instructions that replicate the assembly language sequence;
applying one or more Trojan Horse defining operations to determine whether the instruction sequence comprises one or more instructions associated with one or more Trojan Horses; and
applying one or more virus defining operations to determine whether the instruction sequence comprises one or more self-replicating instructions.

4. The method of claim 1, wherein applying one or more rules comprises:
applying a set of precedential rules to the instruction sequence, wherein the set of precedential rules comprises a plurality of precedential rules, wherein each precedential rule is associated with a precedence with respect to the other precedential rules in the set.

5. The method of claim 4, wherein applying a set of precedential rules comprises applying the precedential rules to the instruction sequence, in order of precedence, until the instruction sequence is classified or each precedential rule has been applied.

6. The method of claim 4, wherein applying a set of precedential rules comprises ranking the precedential rules by giving precedence to rules having a higher number of matches to the instruction sequence.

7. The method of claim 1, wherein classifying the instruction sequence comprises classifying the instruction sequence as threatening if the instruction sequence is unable to be traversed from start to finish.

8. The method of claim 1, wherein classifying the instructions sequence comprises, for each node in the instruction sequence:
traversing the node;
determining whether the node has previously been traversed; and
if so, classifying the instruction sequence as threatening.

9. The method of claim 1, wherein classifying the instruction sequence comprises classifying the instruction sequence as threatening if it includes one or more of the following:
encryption routines;
decryption routines; and
one or more instructions for replicating at least a portion of the instruction sequence.

10. A method of automatically identifying malware, the method comprising:
receiving, by an expert system knowledge base, an assembly language sequence from a binary file;
identifying an instruction sequence from the received assembly language sequence;
classifying, by the expert system knowledge base, the instruction sequence as threatening, non-threatening or non-classifiable by applying one or more rules of the expert system knowledge base to the instruction sequence;
if the instruction sequence is classified as non-threatening, transmitting information to a code analysis component, wherein the information comprises one or more of the following:
the instruction sequence, and
a label comprising an indication that the instruction sequence is non-threatening; and
requesting a second instruction sequence.

11. The method of claim 10, wherein classifying the instruction sequence comprises classifying the instruction sequence as non-threatening if the expert system traverses the instruction sequence in its entirety.

12. A method of automatically identifying malware, the method comprising:
receiving, by an expert system knowledge base, an assembly language sequence from a binary file;
identifying an instruction sequence from the received assembly language sequence;
classifying, by the expert system knowledge base, the instruction sequence as threatening, non-threatening or non-classifiable by applying one or more rules of the expert system to the instruction sequence; and
if the instruction sequence is classified as non-classifiable:
transmitting a request to a code analysis component that the assembly language sequence be reanalyzed,
receiving a new instruction sequence corresponding to the reanalyzed assembly language sequence, and
classifying the new instruction sequence as threatening, non-threatening or non-classifiable.

13. A method of automatically identifying malware, the method comprising:
analyzing, by a code analysis component, a binary file to generate an assembly language sequence and a corresponding instruction sequence;
transmitting the instruction sequence to an expert system knowledge base;
receiving, from the expert system knowledge base, classification information associated with the instruction sequence;
if the classification information identifies the instruction sequence as threatening:
identifying one or more other assembly language sequences from the binary file that comprise at least a portion of the instruction sequence, and
transmitting at least one of the identified assembly language sequences to the expert system knowledge base;
if the classification information identifies the instruction sequence as non-threatening, transmitting a second instruction sequence to the expert system knowledge base; and
if the classification information identifies the instruction sequence as non-classifiable:
reanalyzing the assembly language sequence to produce a new instruction sequence, and
transmitting the new instruction sequence to the expert system knowledge base.

14. The method of claim 13, wherein analyzing a binary file comprises one or more of statically analyzing the binary file and dynamically analyzing the binary file.

15. A system for automatically identifying malware, the system comprising:
a code analysis component configured to identify an assembly language sequence from a binary file, wherein the assembly language sequence comprises one or more instruction sequences; and
an expert system knowledge base in communication with the code analysis component, wherein the expert system knowledge base is configured to classify the instruction sequence as threatening, non-threatening or non-classifiable using one or more rules.

16. The system of claim 15, further comprising a connector logic component in communication with the code analysis component and the expert system knowledge base, wherein the connector logic component is configured to enable communication between the code analysis component and the expert system knowledge base.

17. The system of claim 16, wherein the connector logic component is configured to perform one or more of the following:
convert the instruction sequence into a format that the expert system knowledge base can process; and
convert information received from the expert system knowledge base into a format that the code analysis component can process.

18. The system of claim 14, wherein the expert system knowledge base is populated with one or more of the following:
C Language Integrated Production System rules;
binary file structures;
worm defining operations;
Trojan Horse defining operations; and
virus defining operations.

19. The system of claim 14, wherein the expert system knowledge base is configured to classify the instruction sequence by one or more of the following:
applying one or more rules to the instruction sequence to determine whether a binary file structure of the binary file is proper;
applying one or more worm defining operations to determine whether the instruction sequence comprises one or more instructions that replicate the assembly language sequence;
applying one or more Trojan Horse defining operations to determine whether the instruction sequence comprises one or more instructions associated with one or more Trojan Horses; and
applying one or more virus defining operations to determine whether the instruction sequence comprises one or more self-replicating instructions.

20. The system of claim 14, wherein the expert system knowledge base is configured to apply a set of precedential rules to the instruction sequence, wherein the set of precedential rules comprises a plurality of precedential rules, wherein each precedential rule is associated with a precedence with respect to the other precedential rules in the set.

21. The system of claim 20, wherein the expert system knowledge base is further configured to apply the precedential rules to the instruction sequence, in order of precedence, until the instruction sequence is classified or each precedential rule has been applied.

22. The system of claim 20, wherein the expert system knowledge base is further configured to rank the precedential rules by giving precedence to rules having a higher number of matches to the instruction sequence.
